(19) United States
(12) Patent Application Publication
(10) Pub. No.: US 2009/0178590 A1
(43) Pub. Date: Jul. 16, 2009

(54) METHOD FOR REINFORCING CONCRETE

(75) Inventors: George N. Mitchell, Mars, PA (US); Nicholas C. Mitchell, Gibsonia, PA (US); Keith Foley, Newcastle, PA (US)

Correspondence Address: COHEN & GRIGSBY, P.C., 625 LIBERTY AVENUE, PITTSBURGH, PA, 15222-3152, US

(73) Assignee: Fibercon International, Inc., Evans City, PA (US)

(21) Appl. No.: 12/014,403

(22) Filed: Jan. 15, 2008

(51) Int. Cl. C04B 14/48

(52) U.S. Cl. 106/644

(57) ABSTRACT

A method for making a multi-stage cementitious material with high-temperature reinforcing fibers 22 in an outer zone and lower-temperature reinforcing fibers 24 in an inner zone.

### BACKGROUND OF THE INVENTION

1. Field of the Invention

The presently disclosed invention relates to methods for reinforcing cementitious materials and, more particularly, reinforcing cementitious materials that are used for high-temperature applications.

2. Description of the Prior Art

For many years, various types of reinforcing have been used to strengthen various compositions. For example, U.S. Pat. No. 5,636,492 to Dingler describes construction members that are intended for the replacement of wood sheets or boards. According to that patent, metal reinforcing fibers are distributed in plastic that contains 30%-50% olefins. In some cases, reinforcing has been used in cementitious materials such as cement, mortar and concrete. For example, U.S. Pat. No. 4,190,993 is directed to concrete chimney liners that include wire mesh.

In some cases, reinforcing fibers have been used in cementitious materials to retard the tendency of the cementitious material to crack and thus strengthen the reinforced cementitious materials. Fiber-reinforced cementitious composites are made by mixing the fibers with the cementitious material or by placing the fibers in a mold and then infiltrating the mold with cementitious material. U.S. Pat. No. 4,565,840 describes fiber-reinforced concrete having two types of fibers. The fiber types differ as to Young's modulus. The fibers are mixed according to a predetermined ratio and dispersed in the concrete.

To facilitate a higher concentration of fibers in the composite, it is preferred to place the fibers in a mold and then infiltrate the mold with the cementitious material. In U.S. Pat. No. 5,571,628, the metal fibers are organized in pre-forms that have a selected shape such as an I-beam or a mat and then infiltrated with cementitious composition.

Specialized fibers and combinations of fibers with other ingredients have been used to try to optimize the performance of the cementitious composite. For example, U.S. Pat. No. 3,852,930 describes fibers with a three dimensional structure for use with cement. Another example is shown in U.S. Pat. No. 7,178,597 to Reddy et al. which is directed to cement compositions that are used to cement casings and liners in well bores. Down-hole thermal gradients and variations may sometimes break the seal between the cement and the pipe string. The Reddy et al. patent discloses the use of metallic fibers having an aspect ratio in the range of 1.25 to 400 in the cement composition or glass fibers having an aspect ration of 1.25 to 5,000. U.S. Pat. No. 5,503,670 also is directed to particulars concerning fibers that are used in a concrete composite.

Fiber reinforcing has been used in high-temperature applications such as, for example, in connection with steel-making processes. In such high-temperature applications, the reinforcing fibers must maintain their mechanical strength at the applied temperatures. For example, U.S. Pat. No. 4,366,255 is directed to a highly reinforced concrete that is made by infiltrating metal fibers with an aqueous slurry of a refractory material having a superplasticizer. That patent discloses a method for introducing amounts of fibers in excess of 4% by volume into the composition.

In applications where applied temperatures exceed 1500° F./850° C., the use of stainless steel reinforcing fibers is generally recommended. However, the use of stainless steel fibers also increases the cost of the cementitious material in comparison to cementitious materials that are reinforced with less-costly fiber material. For example, the use of certain grades of stainless steel fibers have been found to make the reinforced cementitious composite up to five times more costly than materials with conventional types of reinforcing fibers such as carbon steel fibers.

The relatively high cost of using reinforced cementitious materials has limited their use for high-temperature applications. In some cases, alternative materials or technologies were employed. Accordingly, there was a need in the prior art for a high-temperature fiber-reinforced cementitious composite that would be more cost-competitive with other fiber-reinforced cementitious materials.

### SUMMARY OF THE INVENTION

In accordance with the presently disclosed invention, a multi-phase cementitious composite is made by locating a first casing inside of a second casing. The two casings define a volume between them as a first zone or a hot zone (hot face). The area inside the first casing is defined as a second zone. High-temperature fibers are fibers for which the maximum service temperature of the fibers is higher than the highest temperature to which the cementitious product is exposed. Thus, the high-temperature fibers will withstand the highest temperature to which the cementitious product is exposed. The high-temperature fibers are placed in the first zone or hot zone. Lower-temperature fibers have a maximum service temperature that is lower than the maximum service temperature of the high-temperature fibers, but higher than the highest temperature that will occur in the second zone at times when the cementitious product is exposed to the highest maximum temperature. Thus, lower-temperature fibers will withstand the highest temperature that occurs within the second zone at times when the cementitious product is exposed to the highest temperature. Lower-temperature fibers are placed in the second zone. The first casing is then removed from the second casing and cementitious material is then poured into the entire mold or second casing which includes both the hot zone and the second zone. When the wet cementitious material has hardened, a two-phase cementitious composite is formed.

Preferably, the high-temperature fibers are made of stainless steel and the lower-temperature fibers are made of carbon steel or a lower grade of stainless steel such as 409 stainless or 430 stainless that contain a lower quantity of chrome and nickel.

Also preferably, the thickness of the first zone is determined according to the highest temperature to which the finished composite will be exposed, the thermal gradient within the finished composite, and the temperature at which the lower-temperature metal fibers begin to lose their mechanical integrity.

Other features, advantages, and objects of the presently disclosed invention will become apparent to those skilled in the art as a description of a presently preferred embodiment thereof proceeds.

### BRIEF DESCRIPTION OF THE DRAWINGS

Several presently preferred embodiments are described and shown with respect to the accompanying drawings wherein:

FIG. 1 is a perspective view of a first casing that is located inside of a second casing.

FIG. 2 is a perspective view of the first casing in FIG. 1.

FIG. 3 is a perspective view of the second casing in FIG. 1.

FIG. 4 is a perspective view of the casings in FIG. 1 with portions thereof broken away to better disclose a first type of reinforcing fiber in the zone between the first and second casings and a second type of reinforcing fiber in the zone inside the first casing.

FIG. 5 is an elevational cross-section of the two-phase cementitious composite formed by the first and second casings of FIG. 4 taken along the line 5-5 and showing two phases of reinforcing fibers.

FIG. 6 is a horizontal cross-section of the cementitious composite formed by the first and second casings of FIG. 4 taken along the line 6-6 and showing two phases of reinforcing fibers.

FIG. 7 is a perspective view of another embodiment wherein a first casing is located inside of a second casing and the first casing is higher than the second casing.

FIG. 8 is a perspective view of the casings of FIG. 7 with portions thereof broken away to better disclose a first type of reinforcing fiber in the zone between the first and second casings and a second type of reinforcing fiber in the zone inside the first casing.

FIG. 9 is an elevational cross-section of the two phase cementitious component formed by the first and second casings of FIG. 8 taken along the line 9-9 and showing two phases of reinforcing fibers.

FIG. 10 is a horizontal cross-section of the cementitious composite formed by the first and second casings of FIG. 8 taken along the line 10-10 and showing two phases of reinforcing fibers.

FIG. 11 is a perspective view of the cementitious composite shown in FIGS. 8-10 with portions thereof broken away to better disclose internal structure.

### DESCRIPTION OF A PRESENTLY PREFERRED EMBODIMENT

Cementitious materials are used in high temperature applications such as steel-making. Typically, the cementitious materials are cast in a desired shape by pouring wet material into a mold and letting it harden. Also in high-temperature applications, various types of fibers are added to the material to strengthen it. Preferably, the fibers are added to the mold and then the liquid cementitious material is poured over the fibers.

Cementitious materials have a relatively high thermal gradient. Thus, when cementitious materials are used in high-temperature applications, the internal temperatures of the cementitious body are lower at locations that are remote from a “hot face” or surface of the cementitious body that is exposed to a high temperature. In the portions of the cementitious material that are adjacent to a hot face or high-temperature surface, high-temperature fibers—i.e., fibers that withstand high temperatures—are needed. However, due to the high thermal gradient of the cementitious material, high-temperature fibers are often not required for portions of the cementitious material that are located at positions that are remote or away from a hot face or high-temperature surface.

In the prior art, the fibers have been homogenously distributed throughout the cementitious material. There has been no commercially practicable method for constructing a metal fiber matrix wherein high-temperature fibers are selectively located in only those regions of the cementitious composites that are adjacent to surfaces that are exposed to high temperatures. Therefore, the high-temperature fibers have been used throughout the cementitious material even though they are only necessary in regions adjacent to the hot face or high-temperature surface.

Accordingly, there was a need in the prior art for a process that would selectively locate high temperature reinforcing fibers in those portions of the cementitious composite that are adjacent to surfaces that are exposed to high temperatures while using less-costly, lower temperature fibers in other portions of the cementitious material.

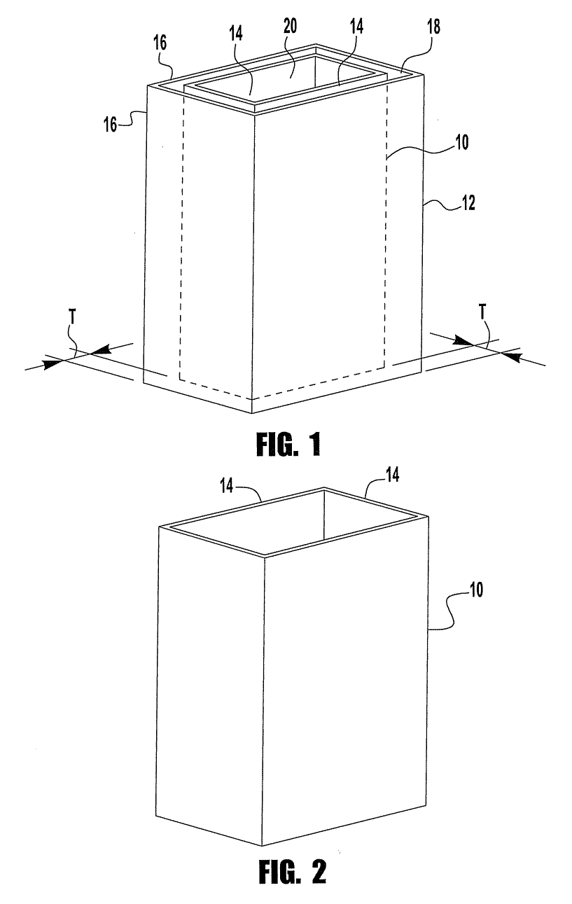

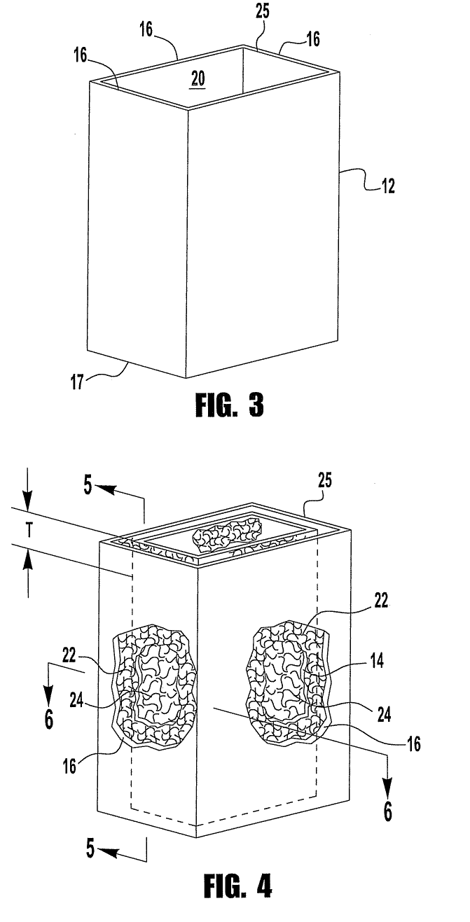

FIGS. 1-6 illustrate a first embodiment of a method for casting a multi-phase cementitious composite wherein high-temperature reinforcing fibers are selectively located in regions adjacent to surfaces that are exposed to high applied temperatures and wherein lower-temperature reinforcing fibers are used in other regions of the composite where internal temperatures do not require a high-temperature reinforcing fiber. According to the disclosed method, a first form or casing 10 is placed inside of a second form or casing 12. Casing 10 has walls 14 but both top and bottom ends of casing 10 are open. Casing 12 has walls 16 and floor 17 at the bottom end with the top end of casing 12 being open. A primary zone or hot zone 18 is defined between walls 14 and walls 16 and a secondary zone 20 is defined between walls 14.

In the example of the preferred embodiment, walls 14 of casing 10 are equidistant from opposing walls 16 of casing 12 so that primary zone 18 has the same thickness (T) throughout. However, many other geometries of casings 10 and 12 are also possible depending on the particular application for the finished cementitious composite. As explained in greater detail below, the separation between adjacent walls 14 and 16 depends on the maximum applied temperature at the surface of the composite, the thermal gradient of the cementitious material, and the temperature at which the reinforcing fibers lose mechanical strength.

High-temperature reinforcing fibers 22 are made of a first material that retains its mechanical integrity or mechanical strength up to a first rated temperature which is the maximum service temperature for the particular material of reinforcing fibers 22. The first rated temperature or maximum service temperature of reinforcing fibers 22 is higher than the maximum temperature to which the hot surface of the cementitious material will be exposed. Reinforcing fibers 22 are placed in primary zone 18. Reinforcing fibers 24 are made of a second material that will retain mechanical integrity or mechanical strength up to a second rated temperature which is the maximum service temperature for the material of reinforcing fibers 24. The second rated temperature or maximum service temperature of reinforcing fibers 24 is higher than the maximum temperature that is developed in zone 20, but is lower than the first rated temperature for reinforcing fibers 22 made from the first material. Reinforcing fibers 24 are placed in zone 20 inside of walls 14 of casing 10.

The normal distance (“T”) between opposing walls 14 and walls 16 is determined according to the thermal gradient of the cementitious material, the maximum temperatures to which the outermost surface or hot surface of the cast composite will be exposed, and the temperature at which the lower-temperature reinforcing fibers 24 begin to lose mechanical integrity. For a given maximum temperature applied to the hot face or outermost surface of the two-stage composite and a given lower-temperature reinforcing fiber 24 with a given second rated temperature, the normal dimension between walls 14 and 16 is determined according to the thermal gradient of the cementitious material. The normal separation between walls 14 and 16 is selected to be equal to or greater than the distance over which the internal temperature of the cementitious material decreases from the maximum exposure temperature at the hot face located at wall 16 to below the second rated temperature at which the second reinforcing fibers 24 will retain their strength at the location of wall 14.

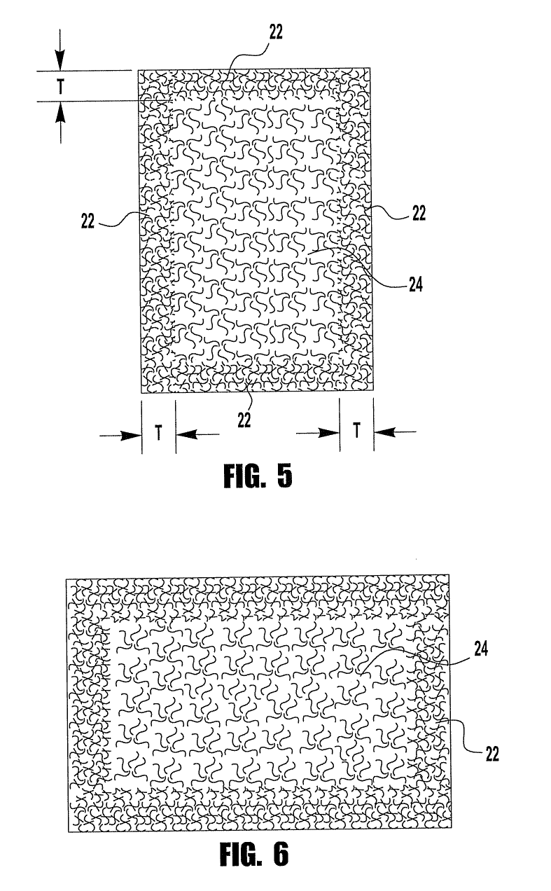

In the example of the preferred embodiment of FIGS. 1-6, the bottom of the finished part is also a hot face that is exposed to high temperatures. As best shown in FIG. 5, the two-phase composite product has a layer of high-temperature reinforcing fibers 22 that are located at the bottom end of the secondary zone 20. To produce this layer of high-temperature reinforcing fibers 22, a layer of high-temperature fibers 22 are placed over floor 17 at the bottom of casing 12 before casing 10 is placed inside of casing 12. The layer of high-temperature fibers 22 has a thickness dimension of “T.” In this way, when fibers 24 are thereafter placed in zone 20, the fibers 24 in zone 20 are separated from the floor 17 of casing 12 by high temperature fibers having a dimension T which is equivalent to the thickness between the walls 16 and 14. As explained above, “T” is selected such that the internal temperature of the cementitous material at the interface of the hot zone and the low-temperature reinforcing fibers 24 will be lower than the second rated temperature for fibers 24.

Alternatively, casing 10 can be inserted inside of casing 12 before the layer of fibers 22 is added. In that case, a layer of fibers 22 having thickness “T” is placed over floor 17 inside of casing 10 before fibers 24 are placed inside casing 10.

Also in the example of the preferred embodiment of FIGS. 1-6, the top of the finished part is also a hot face that is exposed to high temperatures. As best shown in FIGS. 4 and 5, the two-phase composite product has a level finished top that is a hot surface. To produce this top, casing 10 is filled with lower-temperature reinforcing fibers 24 to an elevation that is located at a distance T below the top end 25 of casing 12. In this way, the level of fibers 24 in zone 20 is completed at an elevation that is lower than the top end 25 of second casing 12 by a dimension T which is equivalent to the thickness between walls 16 and 14. As explained above, “T” is selected such that the internal temperature of the cementitious material at the interface of the hot zone and the low-temperature reinforcing fibers 24 will be lower than the second rated temperature for fibers 24.

High-temperature reinforcing fibers 22 are placed in hot zone 18 to an elevation that is at least as high as the level of lower-temperature reinforcing fibers 24. Casing 10 is drawn out of the top end 25 of casing 12 so that walls 14 of casing 10 are no longer opposite the walls 16 of casing 12. This leaves a two-stage fiber reinforcement with the first, high-temperature fibers 22 in an outer zone or hot zone and second, lower-temperature fibers 24 in a lower-temperature inner zone. The open portion of casing 12 is filled with high-temperature reinforcing fibers 22 to the top 25 of casing 12.

In some cases, casing 10 can be drawn out of the top end of casing 12 in stages or steps as the high-temperature reinforcing fibers 22 are placed in zone 18 and the lower-temperature reinforcing fibers 24 are placed in zone 20 on the inside of casing 10. The rate of withdrawal of casing 10 is such that the lower end of casing 10 remains below an elevation at which fibers 22 fill zone 18 and fibers 24 fill zone 20 on opposite sides of the walls 14 of casing 10. In this way, the cumulative frictional force applied by fibers 22 and fibers 24 is reduced so that casing 10 can be more easily withdrawn from fibers 22 and 24.

The wet cementitious material is then poured over the reinforcing fibers 22 and 24 to fill casing 12. The entire casing 12 is vibrated so that the cementitious material and fibers are compacted. Fibers 22 may be added as necessary to maintain finished part geometry. When the cementitious material cures, the result is a hardened composite of reinforcing fibers and cementitious material. The composite is two-stage in that high-temperature fibers 22 are in outer zone 18 and lower-temperature fibers 24 are in inner zone 20. The finished product has a level top with high-temperature fibers 24 and a hot zone on the top surface of the finished product.

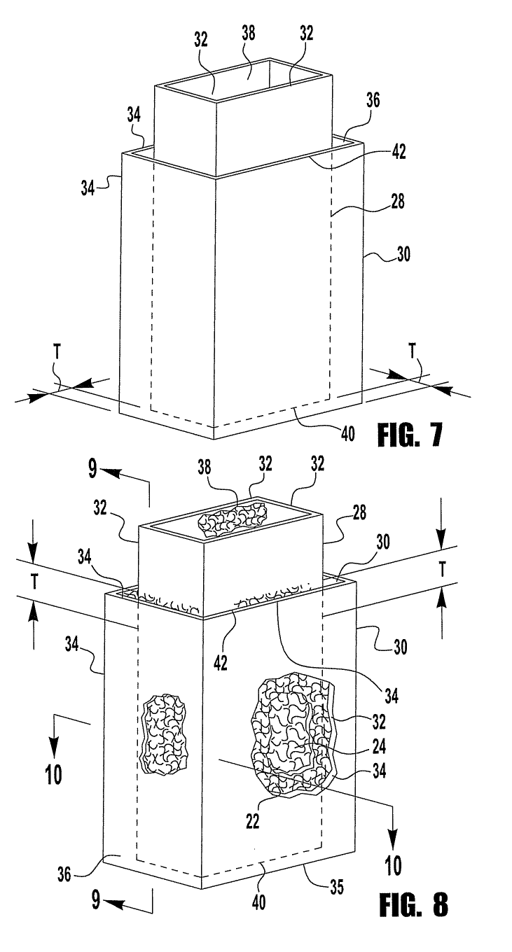

Many other shapes and geometries are also possible with the disclosed method. For example, FIGS. 7-11 illustrate an alternative embodiment in which the top surface of the cast composite is a bi-level surface. A first form or casing 28 is placed inside of a second form or casing 30. Casing 28 has walls 32 but both top and bottom ends of casing 28 are open. Casing 30 has walls 34 and a floor 35 with the top end of casing 30 being open. A primary zone or hot zone 36 is defined between opposing walls 32 and walls 34 and a secondary zone 38 is defined between walls 32.

In the example of FIGS. 7-11, a layer of fibers 22 are placed over the floor 35 of casing 30. The layer of fibers 22 has a thickness “T.” Then casing 28 is inserted inside of casing 30 to establish hot zone 36 between the walls 32 of casing 28 and the walls 34 of casing 30. Then, fibers 22 are placed in zone 36 between walls 32 and 34 and fibers 24 are placed inside casing 28.

Alternatively, casing 28 can be inserted inside of casing 30 before the layer of fibers 22 is added. In that case, a layer of fibers 22 having thickness “T” is placed over floor 35 inside of casing 28 before fibers 24 are placed inside casing 28.

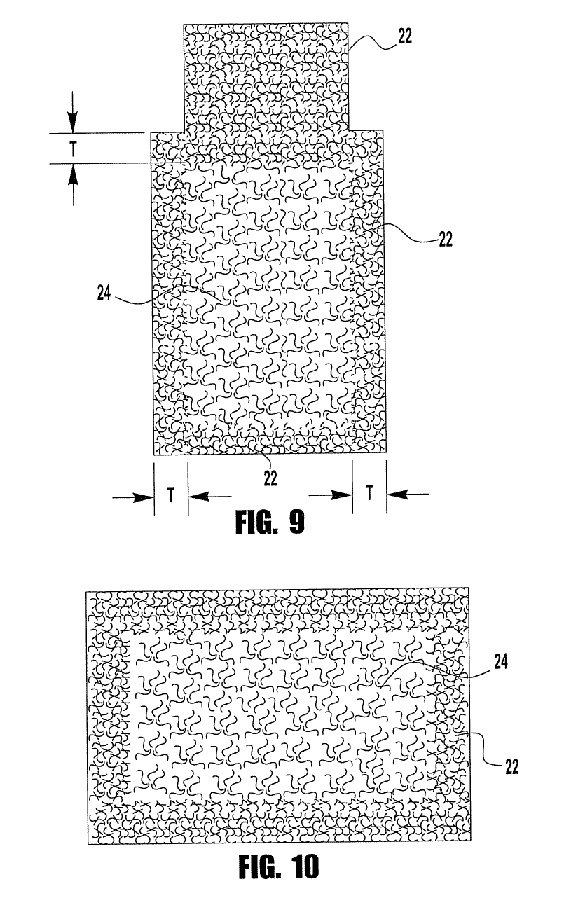

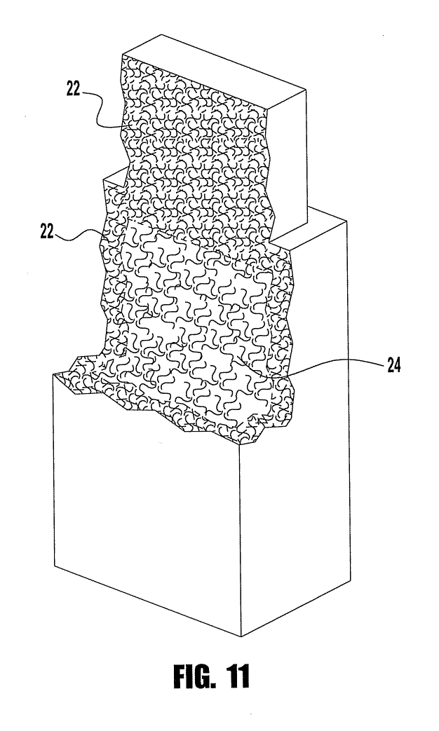

In the example of the preferred embodiment of FIGS. 7-11, the top of the finished part is also a hot face that is exposed to high temperatures. As best shown in FIGS. 9 and 11, the two-phase composite product has a bi-level finished top that is a hot surface. To produce this top configuration, casing 28 is filled with lower-temperature reinforcing fibers 24 to an elevation that is located at a dimension T below the top of casing 30. In this way, the level of fibers 24 in zone 38 is completed at an elevation that is lower than the top end of second casing 30 by a dimension T which is equivalent to the thickness between walls 34 and 32. Fibers 22 are placed in zone 36 at least to an elevation that is a distance T below the top end of second casing 30 or higher.

Casing 28 is then removed from casing 30 by longitudinally withdrawing casing 28 through the open top end of casing 30 until the lower end of casing 28 is positioned at the same elevation as the top end 42 of second casing 30. The balance of casing 30 is then filled with high-temperature reinforcing fibers 22 to the top of casing 30. Casing 28 is also filled with high-temperature reinforcing fibers 22 to an elevation that is the desired height of the central portion of the top of the molded part. This establishes a two-stage fiber reinforcement with the first, high-temperature fibers 22 in an outer zone or hot zone and second, lower-temperature fibers 24 in a lower-temperature inner zone.

Cementitious material is then added to fill casing 30. Cementitious material is also added to fill the lower portion of casing 28 to a level of the desired height of the central portion of the top of the molded part. Casings 28 and 30 are vibrated so that the cementitious material is compacted. Fibers 22 may be added as necessary to maintain finished part geometry. When the cementitious material cures, the result is a hardened composite of reinforcing fibers and cementitious material. The composite is two-stage in that high-temperature fibers 22 are in outer zone 36 and lower-temperature fibers 24 are in inner zone 38. The finished product has a bi-level top with high-temperature fibers 22 and a hot zone on the top surface of the finished product.

While a presently preferred embodiment of the invention is shown and described herein, the presently disclosed invention is not limited thereto, but can be otherwise variously embodied within the scope of the following claims.

We claim:

1.) A method for making a multi-phase cementitious composite, said method comprising the steps of:
locating at least one casing which is a first casing inside of at least one other casing which is a second casing to define a first zone between said first and second casings and a second zone inside of said first casing;
placing lower-temperature fibers in the second zone;
placing high-temperature fibers in the first zone;
removing the first casing from inside the second casing; and
adding cementitious material to the second casing.

2.) The method of claim 1 wherein said high-temperature fibers are comprised of stainless steel.

3.) The method of claim 2 wherein said lower-temperature fibers are comprised of steel fibers selected from the group comprising carbon steel, 409 stainless steel, 430 stainless steel, or combinations thereof.

4.) The method of claim 1 wherein said high-temperature fibers maintain their mechanical strength at temperatures between 1500° F.-2300° F. (815° C.-1260° C.).

5.) The method of claim 2 wherein said lower-temperature fibers maintain their mechanical strength at temperatures between 842° F.-1500° F. (450° C.-815° C.).

6.) The method for making a multi-phase cementitious composite according to claim 1 wherein the minimum dimension between the first casing and the second casing is determined according to the thermal gradient of the cementitious material, the maximum temperature to which the cementitious composite will be exposed, and the maximum service temperature of the lower-temperature fibers.

7.) The method of claim 6 wherein the minimum dimension between the first casing and the second casing is at least great enough so that at times when the surface of the composite is exposed to the maximum temperature, the temperature within the composite at the location of the lower-temperature fibers is less than the maximum service temperature of said lower-temperature fibers.

8.) The method for making a multiphase cementitious composite according to claim 1 wherein a layer of high-temperature fibers covers at least one end of said second zone.

9.) The method of claim 8 wherein the thickness of said layer of high-temperature fibers is determined according to the thermal gradient of the cementitious material, the maximum temperature to which the cementitious composite will be exposed, and the maximum service temperature of said lower-temperature fibers.

10.) The method of claim 8 wherein the maximum thickness of the layer of high-temperature fibers is at least great enough so that at times when the surface at the end of the composite is exposed to the maximum temperature, the temperature within the composite at the interface between the lower-temperature fibers and the layer of high-temperature fibers is less than the maximum service temperature of the lower-temperatures fibers.

11.) The method for making a multiphase cementitious composite according to claim 8 wherein a layer of high-temperature fibers is placed at the bottom end of the second casing before said first casing is located inside of said second casing.

12.) The method for making a multiphase cementitious composite according to claim 8 and further comprising after the step of placing lower-temperature fibers in the second zone, placing a layer of high-temperature fibers in at least one end of said second zone.

13.) The method of claim 1 wherein said removing step comprises drawing said first casing out of said second casing in stages while the high-temperature fibers are placed in said first zone and said lower-temperature fibers are placed in said second zone, said first casing being withdrawn at a rate such that at least a portion of said first casing remains below an elevation at which said high-temperature fibers fill said first zone between said first casing and second casings and also at which said low-temperature fibers fill said second zone on the inside of said first casing.
